(19) United States
(12) Patent Application Publication
(10) Pub. No.: US 2018/0118404 A1
(43) Pub. Date: May 3, 2018

(54) CONTAINERS, METHODS OF MAKING, AND BLANKS THEREFOR

(71) Applicant: K&J Innovations LLC, Valparaiso, IN (US)

(72) Inventors: Krisha J. Drue, Grovertown, IN (US); Jeffrey C. Klingseisen, Valparaiso, IN (US)

(21) Appl. No.: 15/797,270

(22) Filed: Oct. 30, 2017

Related U.S. Application Data
(60) Provisional application No. 62/414,397, filed on Oct. 28, 2016.

(51) Int. Cl. B65D 5/42; B65D 65/40; B65D 5/56; B31B 50/25; B31B 50/26; B29C 45/72; B29C 47/78

(52) U.S. Cl. CPC B65D 5/4279; B65D 65/403; B65D 5/4266; B65D 5/56; B31B 2110/35; B31B 50/26; B29C 45/72; B29C 47/78; B31B 50/25

(57) ABSTRACT

Containers for use as commercial and household (domestic) storage and/or shipping units methods of making the containers, and blanks therefor. The containers include a base panel and sidewall panels formed by folding a single blank to define a cavity within the container and a top edge of the container. The base panel and sidewall panels are formed from the blank such that material of the blank is continuous at edge corners of the container between adjacent panels of the base panel and sidewall panels from lower corners of the container at the base panel to the top edge of the container. The base panel, sidewall panels, and the edge and lower corners of the container are watertight.

### CROSS REFERENCE TO RELATED APPLICATIONS

This application claims the benefit of U.S. Provisional Application No. 62/414,397, filed Oct. 28, 2016, the contents of which are incorporated herein by reference.

### BACKGROUND OF THE INVENTION

The present invention generally relates to articles produced from polymeric materials, including polymer panels (boards) of the type that form storage and shipping containers used in commercial and household (domestic) settings.

As used herein, the terms “container” and “containers” will refer to structures suitable for use as storage and/or shipping and commonly manufactured in the form of boxes, crates, bins, baskets, tubs, drawers, etc. FIG. 1 schematically represents a nonlimiting example of a container. Rigid plastic boxes are a type of container constructed of polymer panels (boards). Such containers and their polymer panels can be manufactured by injection molding, plastic extrusion, thermoforming, and other processes. Polymer panels formed by extrusion offer certain advantages, including wider varieties of shapes that can be produced, for example, a variety of cross-sectional shapes such as corrugated cross-sections with various internal ribs/webs that promote the strength of the panels and containers constructed therefrom.

### BRIEF DESCRIPTION OF THE INVENTION

The present invention provides containers that comprise one or more polymer or paper-based panels and are suitable for use as commercial and household (domestic) storage and/or shipping units.

According to one aspect of the invention, a container is provided that includes a base panel and sidewall panels formed by folding a single blank to define a cavity within the container and a top edge of the container. The base panel and sidewall panels are formed from the blank such that material of the blank is continuous at edge corners of the container between adjacent panels of the base panel and sidewall panels from lower corners of the container at the base panel to the top edge of the container. The base panel, sidewall panels, and the edge and lower corners of the container are watertight.

Other aspects of the invention include containers and blanks that incorporate of a volatile chemical compound into a material from which the containers and blanks are formed wherein the volatile chemical compound exudes a scent or fragrance, blanks used to form the container that are formed of a paper-based material having a water-resistant coating material deposited thereon, and methods of folding a blank to produce containers.

Technical aspects of the container described above preferably include the ability to store and/or transport items in a water-tight container environment without the need to glue or otherwise seal the corners of the container.

Various aspects and advantages of this invention will be better appreciated from the following detailed description.

### BRIEF DESCRIPTION OF THE DRAWINGS

FIG. 1 is a perspective view of a schematic representation of a container.

FIG. 2 is a perspective view that schematically represents a container in accordance with a nonlimiting embodiment of the invention.

FIGS. 3A through 3C schematically represents top, front, and side views, respectively, of the container of FIG. 2.

FIGS. 4A and 4B represent, respectively, plan and fragmentary cross-sectional views of a blank capable of producing the container of FIG. 2 in accordance with a nonlimiting aspect of the invention.

FIG. 5 is an image showing a preferred edge configuration for the container and blanks represented in FIGS. 2 through 4.

### DETAILED DESCRIPTION OF THE INVENTION

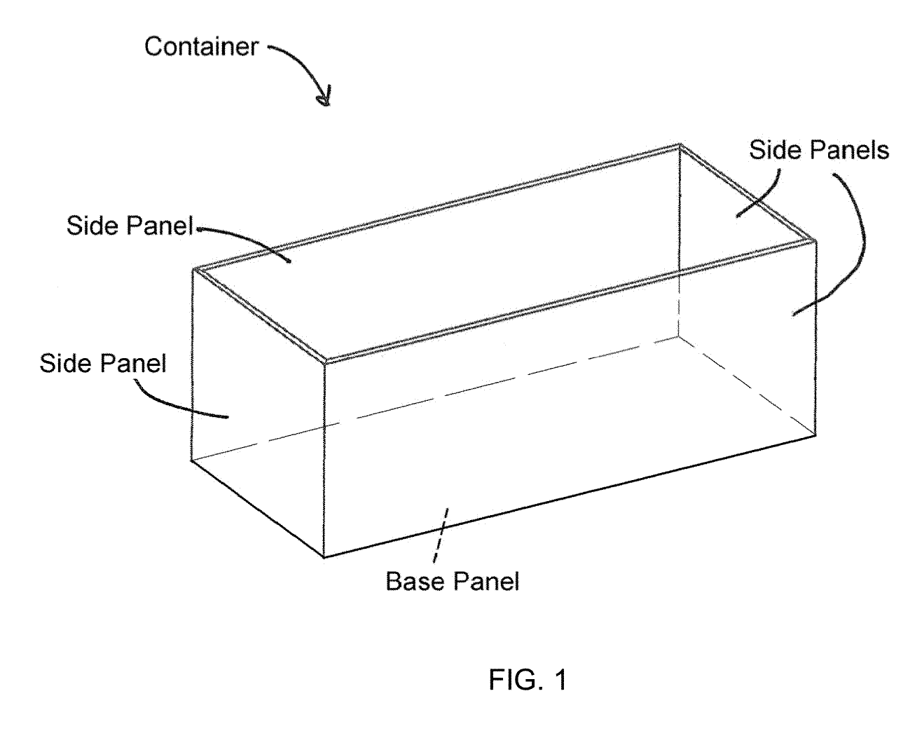

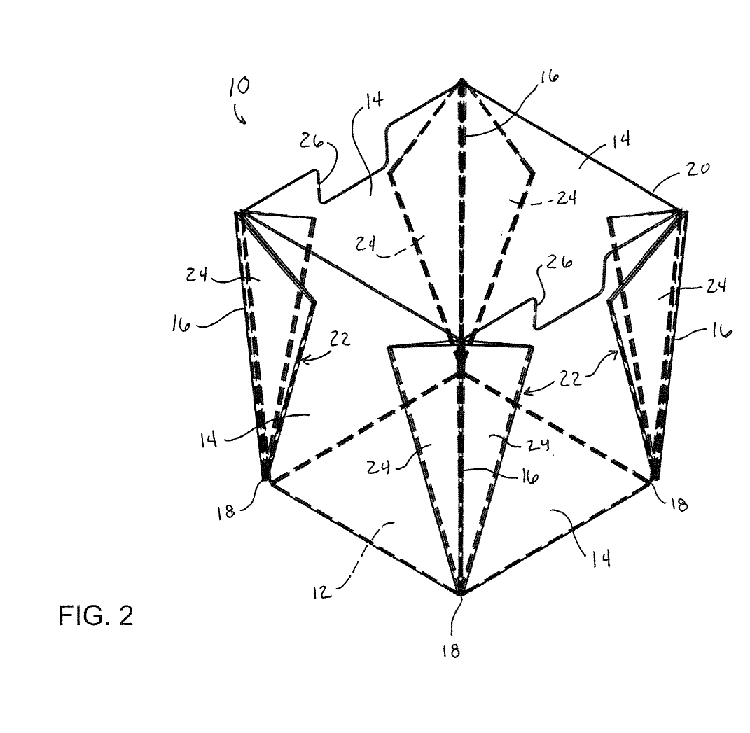

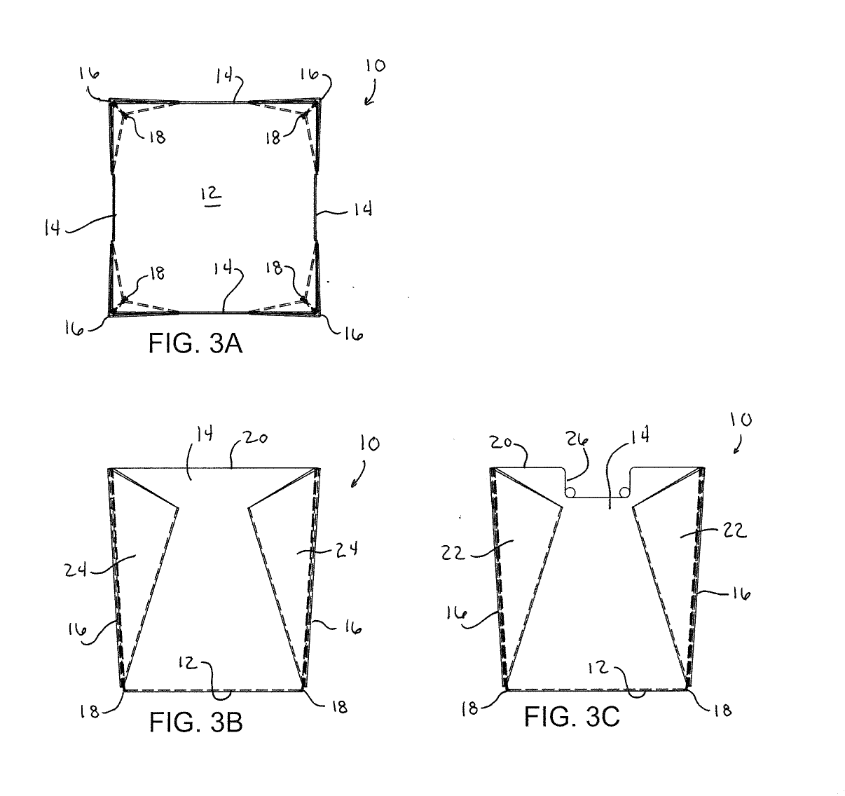

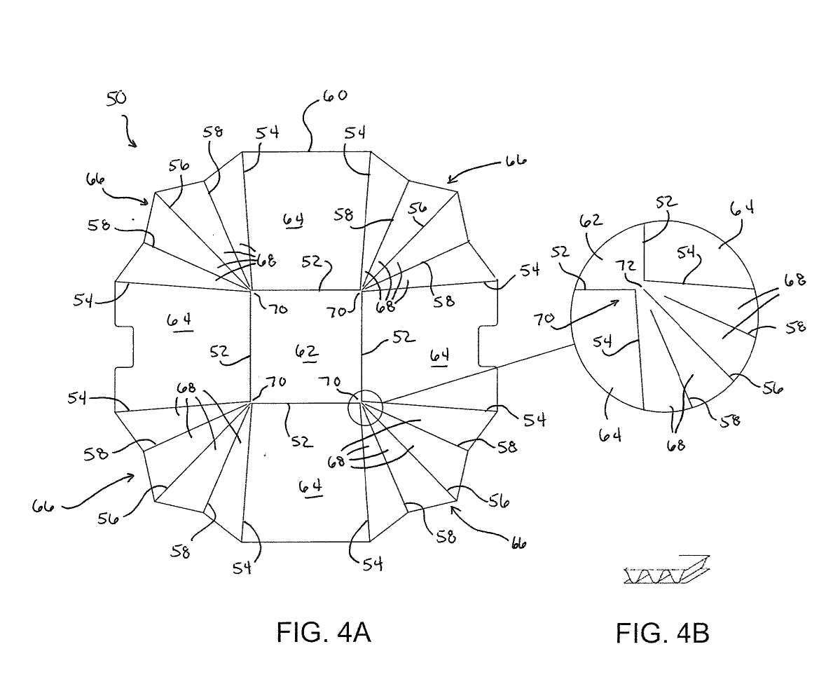

The invention generally relates to containers suitable for use in commercial or household (domestic) storage or shipping applications. Embodiments of the present invention will be described in particular reference to a container 10 represented in FIGS. 2, 3A-3C, and 5 formed by a blank 50 represented in FIG. 4A, though it should be understood that the invention is not limited to the illustrated container 10 or blank 50. The following discussion will focus primarily on aspects of the container 10 that differ from the container of FIG. 1 in some notable or significant manner. Other aspects of the container 10 not discussed in any detail can be, in terms of structure, function, materials, etc., essentially as was described for the container of FIG. 1.

FIG. 2 schematically represents the nonlimiting embodiment of the container 10 as comprising, but is not limited to, a base panel 12 and four upstanding sidewall panels 14 formed by folding the one-piece blank 50 represented in FIG. 4A. The container 10 is preferably a one-piece structure formed by a folding process performed on the blank 50. The base panel 12 and sidewall panels 14 cooperate to define a cavity within the container 10, edge corners 16 of the container 10 therebetween such that each corner 16 is between two of the panels 12 and 14, and lower corners 18 where the base panel 12 adjoins two adjacent sidewall panels 14. Due to the one-piece structure of the container 10 and the manner in which the blank 50 is folded to form the container 10, the corners 16 and 18 of the container 10 are inherently sealed along their entire lengths, that is, the material of the blank 50 from which the container 10 is formed is continuous between adjacent panels 12 and 14 from the base panel 12 to the top edge 20 of the container 10. In so doing, the edge corners 16 are formed and closed by corner panels 22, each having two triangular-shaped portions 24 are formed on either side of each corner 16. As such, the corners 16 are not required to be formed by adhesively bonding or otherwise attached adjacent edges of the panels 12 and 14. Moreover, by forming the blank 50 of a liquid-impervious material, the container 10 may be liquid sealed (watertight) between the panels 12 and 14 without the use of a water-insoluble adhesive or other means at edges of the panels 12 and 14.

Two oppositely-disposed sidewall panels 14 of the container 10 are represented in the drawings as each having a recess 26 formed in the portion of the top edge 20 defined by the panel 14, so as to provide a means to grasp the container 10 if stowed on a shelf with limited clearance between the top edge 20 of the container 10 and a shelf above the container 10. Optionally, the container 10 may include one or more handles, for example, by forming or attaching handles that bridge the recesses 26. Such handles may be formed of the same material as the base and sidewall panels 12 and 14 or may be formed of a different material that is secured to the container 10 prior to or after folding of the blank 50 to form the container 10.

FIG. 4A represents the blank 50 as having score lines 52, 54, 56, and 58 formed therein which facilitate folding of the blank 50 in order to produce the container 10. The score lines 52, 54, 56, and 58 also define sections of the blank 50 that will define the panels 12, 14, and 22 of the container 10. The score lines 52 define the perimeter of a base panel section 62 that will define the base panel 12. The score lines 52 and 54 and perimeter 60 of the blank 50 define the perimeters of four sidewall panel sections 64, each of which has an edge at a score line 52 that connects the sidewall panel section 64 to a respective edge of the base panel section 62. The score lines 54 and perimeter 60 of the blank 50 define the perimeters of at least four corner panel sections 66 between adjacent sidewall panel sections 64, and the score lines 56 and 58 lie within the corner panel sections 66 to define four triangular-shaped sections 68 within each corner panel section 66. The score lines 56 and 58 extend from the perimeter 60 of the blank 50 to converge at an intersection 70 of the score lines 52, 54, 56, and 58 where the lower corners 18 of the container 10 are formed.

The blank 50 is folded along the score lines 52, 54, 56, and 58 so that the score lines 52 define corners of the container 10 that adjoin the base panel 12 to the sidewall panels 14, the edges of adjacent sidewall panel sections 64 (defined by the score lines 54) and the score line 56 of the corner panel section 66 therebetween fold inward to contact each other and form the interiors of the edge corners 16 of the container 10 that adjoin adjacent sidewall panels 14, and the score lines 58 of the corner panel sections 66 fold outwardly to form edges of the triangular-shaped sections 68 of each corner panel 22, which are then folded away from each other and over the exterior surfaces of the adjacent sidewall panels 14 and secured thereto, for example, by gluing. As such, the blank 50 is configured to be folded along the score lines 52, 54, 56, and 58 such that, from the perspective of the blank 50 shown in FIG. 4A, folds formed by the score lines 54 and 56 are inward folds that contact each other to form the interiors of the corners 16 facing the interior of the container 10, and folds formed by the score lines 58 are outward folds that form edges of the triangular-shaped portions 24 of the corner panels 24. To further facilitate the folding operation, the score lines 56 and 58 may be double score lines formed in the blank 50, whereas the score lines 52 and 54 may be single score lines.

An inset view in FIG. 4A shows a detail of the intersection 70 defined by a converging set of the score lines 52, 54, 56, and 58, where the score lines 52 and 54 of adjacent sidewall panels 14 meet to define one of the lower corners 18 between the adjacent sidewall panels 14. From this view, it can be seen that each score line 52 intersects one of the score lines 54, but the score lines 52 do not intersect each other and the score lines 54 do not intersect each other, creating an offset or gap 72 therebetween. Furthermore, not of the score lines 56 and 58 intersect the score lines 52 and 54, and the score lines 58 terminate closer to the intersections 70 of the score lines 52 and 54 than do the score lines 56. This configuration has been found to facilitate the folding operation and the ability of the panels 12, 14, and 22 of the container 10 to converge to reliably form the corners 18 in a manner that the corners 18 can be made watertight.

The blank 50 may be formed of a polymeric material or may be formed of a paper-based material. If the blank 50 is formed of a paper-based material, it preferably has a water-resistant coating thereon that renders the container 10 watertight. A particularly suitable water-resistant coating is an aqueous-based coating commercially available under the name “GreenGuard Rain” from GreenGuard Engineered Coatings, of Massillon, Ohio USA. This coating may be deposited on either or both surfaces of the blank 50.

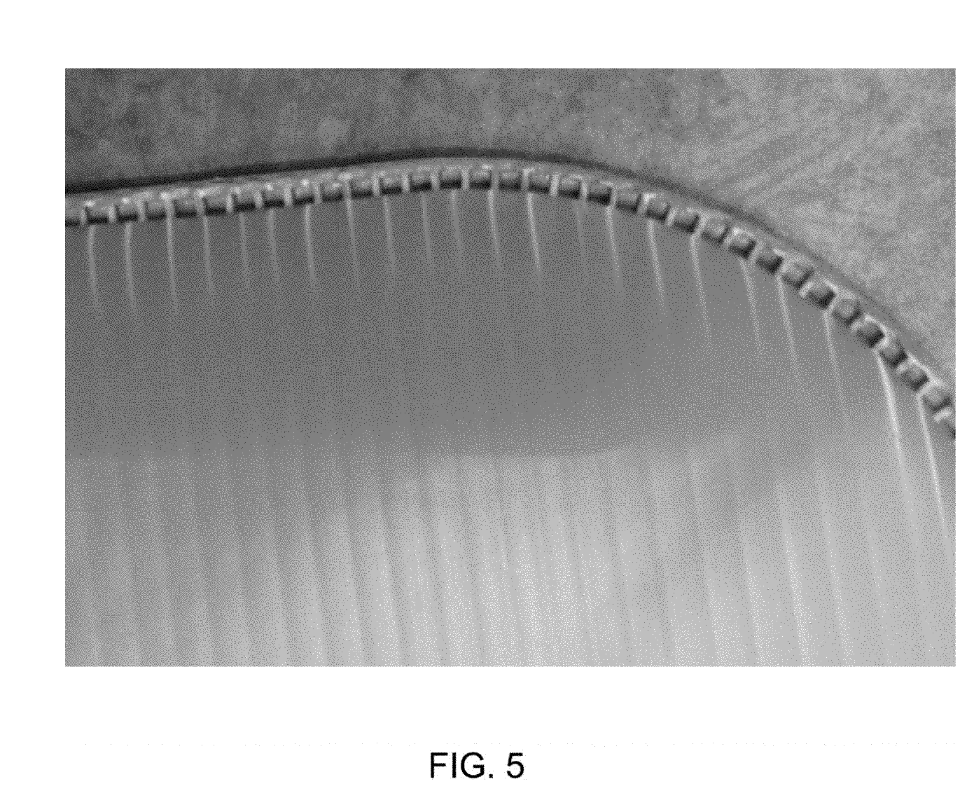

The blank 50 used to construct the container 10 may have various constructions. As nonlimiting examples, the blank 50 (and therefore the panels 12 and 14) may have a thickness in a range of about 1.5 to about 10 mm. A blank 50 formed of a paper-based material preferably has a thickness in a range of about 1.5 to about 3 mm. As represented in FIG. 4B, the blank 50 may have a corrugated construction in which a pair of roughly parallel exterior walls are separated but interconnected by interior reinforcement, for example, ribs or webbing therebetween, to promote the structural strength of the panels 12 and 14. Such reinforcement may define what are commonly referred to as sinusoidal-, X-, H-, W-, or honeycomb-shaped patterns that create voids within the interiors of the panels 12 and 14 between their exterior walls. The edges of a blank having such a corrugated construction (and define the top edge 20 of the container 10) may be sealed to prevent ingress of liquids into the voids within the panels 12 and 14, for example in the case of a polymeric container 10, by a process that heat seals the edges with a brass pattern as represented in FIG. 5.

According to a nonlimiting and optional aspect of the invention, at least a portion of the blank 50 that forms one or more of the panels 12, 14, and 22 of the container 10 (or another container, such as the generic container of FIG. 1) may be formed of a polymeric material, such as but not limited to polypropylene or polyethylene, into which a volatile chemical compound has been incorporated so that the container 10 exudes a pleasant scent or fragrance. Such a blank 50 (or portions thereof) can be manufactured to exude a wide variety of fragrances. In preferred embodiments, one or more individual panels 12, 14, and/or 22 are entirely formed of a polymeric material that incorporates at least one volatile chemical compound. The volatile chemical compound is preferably incorporated into the polymeric material during the process of forming the panel, in other words, as the polymeric material is being shaped/deformed/molded and solidified to form the panel. For example, solid beads of the desired polymeric material can be mixed with a powder that contains the desired volatile chemical compound (for example, an oil) prior to heating and melting (or at least partially melting or softening) the beads and introducing the resulting mixture into a suitable mold, for example, an injection mold or extruder. In a nonlimiting example, the volatile compound may include a food additive, such as but not limited to an artificial vanilla (synthetic vanillin; C₈H₈O₃). In certain embodiments, the volatile chemical compound can be incorporated into the polymeric material in amounts of about 0.25 to about 50 percent by weight. For panels 12, 14, and/or 22 of equal size, a panel having a corrugated construction may have a greater exposed surface area over which the volatile chemical compound can evaporate, thereby increasing the fragrance of the panel perceptible by humans. If the blank 50 is formed of a coated, paper-based material, the volatile chemical compound may be directly incorporated into the paper-based material, though other options are foreseeable.

While the invention has been described in terms of specific or particular embodiments, it is apparent that other forms could be adopted by one skilled in the art. For example, blanks formed of a polymeric material or coatings on paper-based materials that incorporate a volatile chemical compound can find uses in a wide variety of applications other than containers, various polymeric, paper, and fragrant materials could be used to form panels, and various colorants and dyes may be dispersed in the materials. Furthermore, containers and their components could differ in appearance and construction from the embodiment described herein and shown in the drawings. Accordingly, it should be understood that the invention is not limited to any embodiment described herein or illustrated in the drawings. It should also be understood that the phraseology and terminology employed above are for the purpose of describing the illustrated embodiment, and do not necessarily serve as limitations to the scope of the invention. Therefore, the scope of the invention is to be limited only by the following claims.

1. A container comprising:
a base panel and sidewall panels formed by folding a single blank to define a cavity within the container and a top edge of the container, the base panel and sidewall panels are formed from the blank such that material of the blank is continuous at edge corners of the container between adjacent panels of the base panel and sidewall panels from lower corners of the container at the base panel to the top edge of the container, the base panel, sidewall panels, and the edge and lower corners of the container being watertight.

2. The container of claim 1, wherein each of the edge corners is closed by a corner panel, and each corner panel has two triangular-shaped portions disposed on opposite sides of the edge corner thereof.

3. The container of claim 1, further comprising a colorant or dye dispersed in the material from which the blank is formed.

4. The container of claim 1, wherein the blank has a thickness of about 1.5 to about 10 mm.

5. The container of claim 1, wherein the blank has a corrugated construction including a pair of substantially parallel exterior walls separated but interconnected by interior reinforcement.

6. The container of claim 5, wherein at least some edges of the blank are sealed to prevent ingress of liquids into voids within the corrugated construction of the blank between the exterior walls.

7. The container of claim 1, further comprising a volatile chemical compound incorporated into a material from which the blank is formed that exudes a scent or fragrance.

8. The container of claim 7, wherein the material of the blank contains about 0.25 to about 50 percent of the volatile chemical compound by weight.

9. The container of claim 1, wherein the blank is formed of a paper-based material having a water-resistant coating material deposited thereon.

10. The container of claim 9, wherein the coating material is an aqueous-based coating.

11. A method of making the container of claim 1, the method comprising:
forming the blank of a paper-based material having first and second sides;
depositing a water-resistant coating material on at least the first side; and
folding the blank to form the container, wherein at least portions of the first side form an interior surface of the container.

12. The method of claim 11, further comprising scoring the blank along fold lines prior to folding the blank.

13. The method of claim 11, further comprising:
incorporating a powder containing a volatile chemical compound into the paper-based material prior to depositing the water-resistant coating material on at least the first side, the volatile chemical compound exuding a scent or fragrance.

14. The container of claim 1, wherein the blank is formed of a polymeric material.

15. The container of claim 14, wherein the polymeric material is a polypropylene or polyethylene material.

16. A method of making the blank of claim 1, the method comprising:
combining a polymeric material and a powder containing a volatile chemical compound that exudes a scent or fragrance;
heating the polymeric material and the powder to form a mixture; and
introducing the mixture into a mold to form the blank.

17. The method of claim 16, wherein the mold is an injection mold or extruder.

18. A method of folding a blank to produce a container, the method comprising:
producing score lines on the blank that define a base panel section, four sidewall panel sections each having an edge connected to a respective edge of the base panel section, and corner panel sections each of which is between adjacent pairs of the sidewall panel sections, wherein the corner panel sections are defined by some of the score lines that extend from a perimeter of the blank to an intersection of score lines of the adjacent pairs of the sidewall panel sections;
folding the blank along the score lines such that edges of the adjacent pairs of the sidewall panel sections and first edges of one of the corner panel sections therebetween fold inward and contact each other so that each of the adjacent pair of sidewall panel sections forms an adjacent pair of sidewall panels of the container, the edges of the adjacent pairs of the sidewall panel sections and the first edges of the corner panel sections therebetween form interiors of edge corners of the container within an interior of the container, and second edges of each of the corner panel sections are folded outwardly to form edges of two folded panels that extend outwardly from the edge corners of the container;
folding the two folded panels at each of the edge corners away from each other and over an exterior surface of each of the adjacent pair of the sidewall panels; and
securing the two folded panels to the exterior surfaces of the adjacent pair of the sidewall panels.

19. The blank of claim 1.

20. The blank of claim 18.
